(19) United States
(12) Patent Application Publication
(10) Pub. No.: US 2026/0052300 A1
(43) Pub. Date: Feb. 19, 2026

(54) HUNTING CAMERA

(71) Applicant: Dongguan HDKing Smart Technology Co.,LTD., Dongguan (CN)

(72) Inventors: BOLIN HAN, Dongguan (CN); YONGCHUN REN, Dongguan (CN)

(21) Appl. No.: 18/813,514

(22) Filed: Aug. 23, 2024

(30) Foreign Application Priority Data
Aug. 13, 2024 (CN) 202421959356.3

(51) Int. Cl. H04N 23/51; H02J 7/35

(52) U.S. Cl. CPC H04N 23/51; H02J 7/35

(57) ABSTRACT

A hunting camera includes a camera main body and a solar panel, wherein the solar panel is detachably mounted on the camera main body and electrically connected with the camera main body. The camera can be powered through the solar panel, so that the service time of the hunting camera is prolonged. The solar panel is detachably connected with the camera main body, so the solar panel can be placed at sunny places. The camera main body can be placed at an appropriate place to capture shooting, so that the camera is convenient for the user to use, the practicality of the hunting camera is increased, and the user experience is improved.

### CROSS-REFERENCE TO RELATED APPLICATIONS

The application claims priority of Chinese patent application CN2024219593563, filed on 2024-08-13, which is incorporated herein by reference in its entireties.

### TECHNICAL FIELD

The present disclosure relates to a camera, in particular to a hunting camera applied to the technical field of hunting accessories.

### BACKGROUND

The hunting camera, also known as a shooting camera, is a special camera. The hunting camera is an unattended camera that can automatically capture the motion state of people or animals in the wild. The hunting camera is in a dormant state by default. Only when people or animals move into the shooting sight of the camera through pyroelectric infrared detection, the camera is quickly started for continuous capturing or video recording. The hunting camera is convenient for hunters or observers to understand the moving directions of prey.

The existing hunting camera is basically powered by the battery, but the storage capacity of the battery is limited, so the user needs to change standby batteries frequently, or the camera needs to be charged when the electricity of the battery runs out. Battery replacement is more convenient than direct charging for the hunting camera, and the capture time cannot be delayed. However, in general circumstances, the hunting camera is tied to high places, so it is very troublesome for the user to take the camera, and troubles are caused to the user.

### SUMMARY

Aiming at the problem mentioned in the prior art that the battery is inconvenient for the hunting camera user to replace, the present disclosure provides a hunting camera. The camera main body is connected to a solar panel, and the camera can be powered through the solar panel, so that the service time of the hunting camera is prolonged. The solar panel is detachably connected with the camera main body, so the solar panel can be placed at sunny places. The camera main body can be placed at an appropriate place to capture shooting, so that the camera is convenient for the user to use, the practicality of the hunting camera is increased, and the user experience is improved.

The technical solution adopted by the present disclosure to solve the technical problem is as follows.

A hunting camera includes a camera main body and a solar panel, wherein the solar panel is detachably mounted on the camera main body and electrically connected with the camera main body.

Further, the hunting camera also includes a support, the solar panel is arranged at one end of the support, and the other end of the support is detachably arranged on the camera main body.

Further, more than one preformed hole is formed in the support, so that the support is connected with a platform through the preformed hole by using a fixed part.

Further, a plug-in mounting groove is formed in a side face of the camera main body, an elastic clamp is arranged at an opposite end of one end, provided with the solar panel, of the support, the elastic clamp includes a first elastic part and a second elastic part, the first elastic part and the second elastic part are arranged in parallel, outer side faces of the first elastic part and the second elastic part are provided with lugs, the support is respectively clamped to tail ends of two side walls of the plug-in mounting groove through the two lugs on the elastic clamp so that the solar panel is mounted on the camera main body.

Further, the plug-in mounting groove is internally provided with a guide rail along a plug-in mounting direction of the support, a guide groove is formed in the support, and the guide groove can slide along the guide rail.

Further, tail ends of two side walls of the plug-in mounting groove are provided with lengthened sections, the lengthened sections are lengthened towards mutually approaching directions, and the lugs on the first elastic part and the second elastic part are respectively clamped to the lengthened sections.

Further, top surfaces of two side walls of the plug-in mounting groove are provided with bulges extended towards the inner direction of the plug-in mounting groove, a first gap is formed between the bulge and a side wall of the camera main body, and both sides of the support are pluggable in the first gaps.

Further, the solar panel is movably arranged on the support.

Further, the hunting camera also includes a connecting piece, one end, connected with the solar panel, of the support is provided with a first connecting plate, a first mounting hole is formed in the first connecting plate, the bottom of the solar panel is provided with a second connecting plate, a second mounting hole is formed in the second connecting plate, the connecting piece is pluggable in the first mounting hole and the second mounting hole so that the solar panel is connected with the support, and the solar panel is rotatably connected to the connecting piece through the second connecting plate.

Further, the support includes a transverse plate and a vertical plate, one end of the vertical plate is connected with the camera main body, the other end of the vertical plate is connected with one end of the transverse plate, the transverse plate and the vertical plate are vertically arranged, and the first connecting plate is arranged at the other end of the transverse plate.

Further, the transverse plate and the vertical plate are integrally formed, and reinforcing ribs are arranged at the joint of the transverse plate and the vertical plate.

Further, three first connecting plates are arranged, two second connecting plates are arranged, a second gap is formed between every two first connecting plates, and when the first connecting plates and the second connecting plates are connected with the connecting piece, one of the second connecting plates is located in one second gap, and the other of the second connecting plates is located in the other second gap.

Further, the connecting piece includes a bolt and a nut, an axial part of the bolt includes a threaded section and a smooth section, the threaded section is arranged at the tail of the axial part of the bolt, the smooth section is arranged between a bolt head part of the bolt and the threaded section, the bolt is pluggable in the first mounting hole and the second mounting hole, and when the bolt is plugged in the first mounting hole and the second mounting hole, the first connecting plate and the second connecting plate are connected to the smooth section, and the nut is detachably connected to the threaded section.

Further, the bolt head part of the bolt includes a handheld part, a nut hole connected with the first mounting hole is formed in the first connecting plate, and when the axial part of the bolt is plugged in the first mounting hole, the threaded section is located in the nut hole, and the nut can be mounted in the nut hole.

Further, the bolt head part of the bolt also includes a lengthened part, and the lengthened part is arranged between the handheld part and the smooth section.

Further, the hunting camera also includes a display screen, and the display screen is arranged on a front face of the camera main body.

Further, the hunting camera also includes indicator lights, and the indicator lights are used for displaying signals.

Further, the indicator lights include a power indicator light, a camera starting state indicator light, a card-insertion state indicator light and a signal connection indicator light.

Further, the hunting camera also includes a waterproof ring and a battery, the camera main body also includes an upper shell and a lower shell, the upper shell and the lower shell are mutually closed, a gap closed between the upper shell and the lower shell is sealed by the waterproof ring to form a sealing cavity, and the battery is arranged in the sealing cavity.

Further, the upper shell and the lower shell are fixedly connected.

Beneficial effects: The present disclosure provides a hunting camera. The camera main body is connected to a solar panel, and the camera can be powered through the solar panel, so that the service time of the hunting camera is prolonged. The solar panel is detachably connected with the camera main body, so the solar panel can be placed at sunny places. The camera main body can be placed at an appropriate place to capture shooting, so that the camera is convenient for the user to use, the practicality of the hunting camera is increased, and the user experience is improved. The solar panel is convenient for the user to disassemble through the arrangement of the elastic clamp. The solar panel is rotatably connected to the support, so that the angle of the solar panel is conveniently adjusted by the user.

### BRIEF DESCRIPTION OF THE DRAWINGS

FIG. 1 is a front face space diagram of a hunting camera with a display screen provided by the present disclosure.

FIG. 2 is a front face space diagram of a hunting camera without a display screen provided by the present disclosure.

FIG. 3 is a back face space diagram of a camera main body provided by the present disclosure.

FIG. 4 is a back face space diagram of a hunting camera provided by the present disclosure.

FIG. 5 is an explosive view of a structural relationship between a support and a solar panel provided by the present disclosure.

FIG. 6 is an explosive view of a structural relationship of FIG. 5 in another visual angle provided by the present disclosure.

FIG. 7 is an explosive view of a camera main body provided by the present disclosure.

### DETAILED DESCRIPTION OF THE EMBODIMENTS

In order to make the aims, technical solution and advantages of the present disclosure will be clearly, the present disclosure is further described below in combination with accompanying drawings and implementations. It should be understood that the specific embodiments described herein are intended only to explain the present disclosure and are not intended to define the present disclosure.

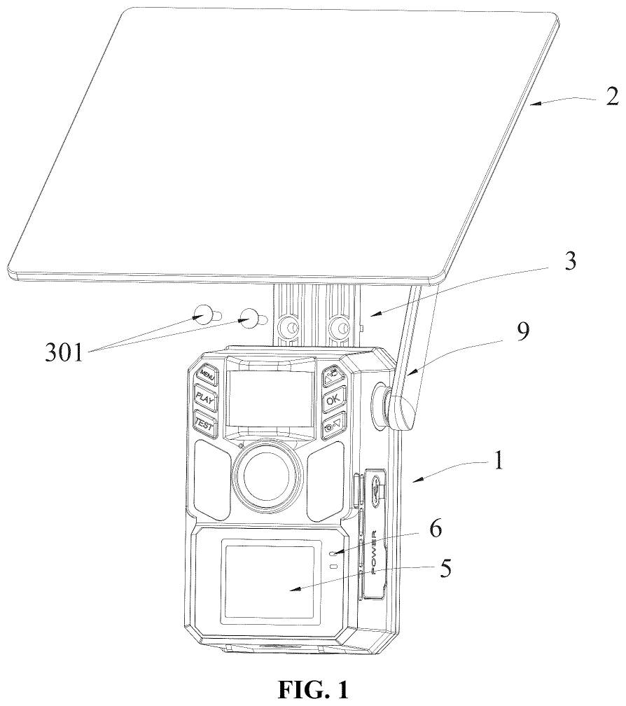

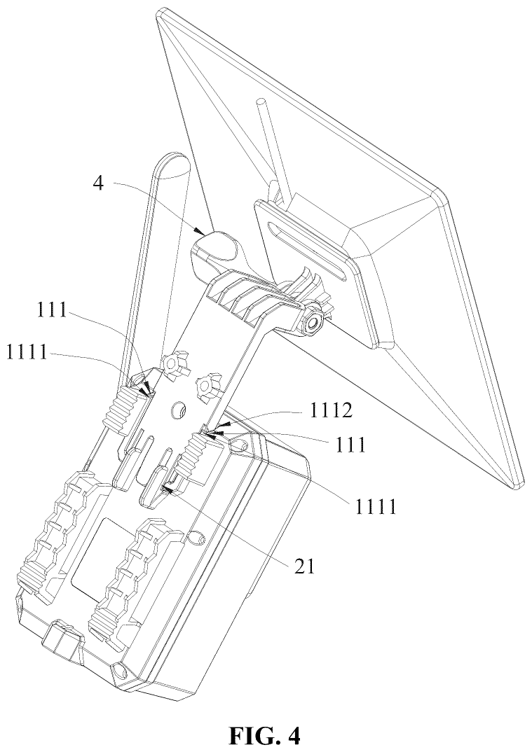

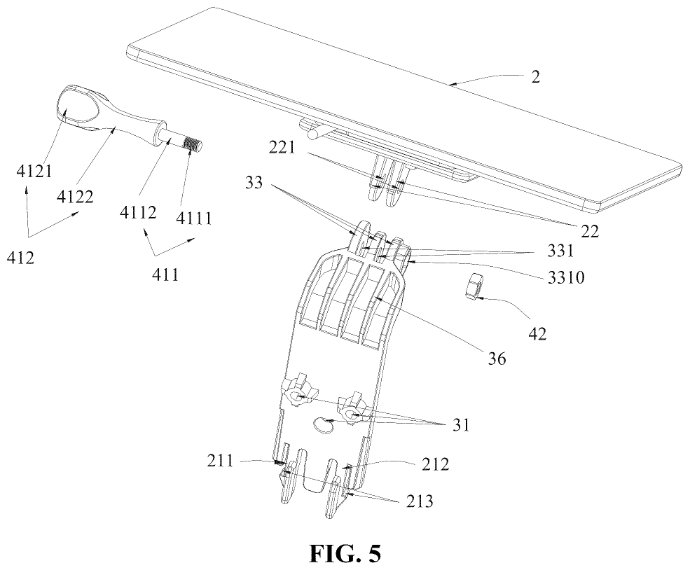

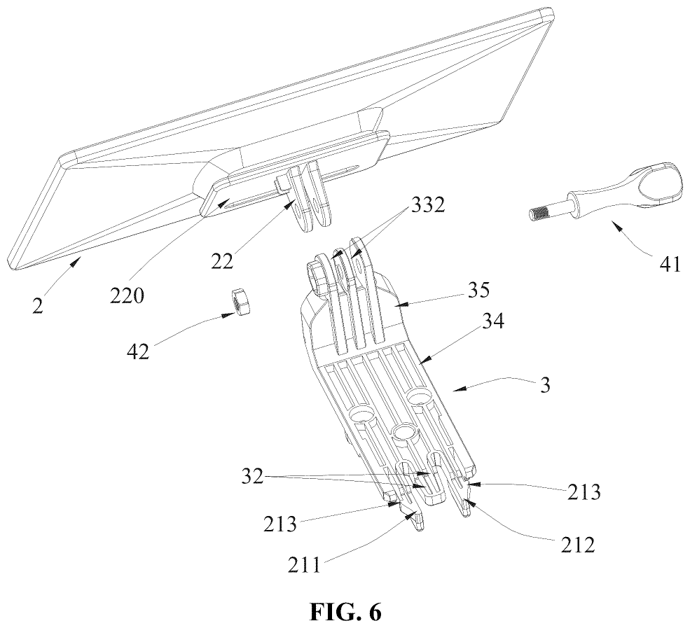

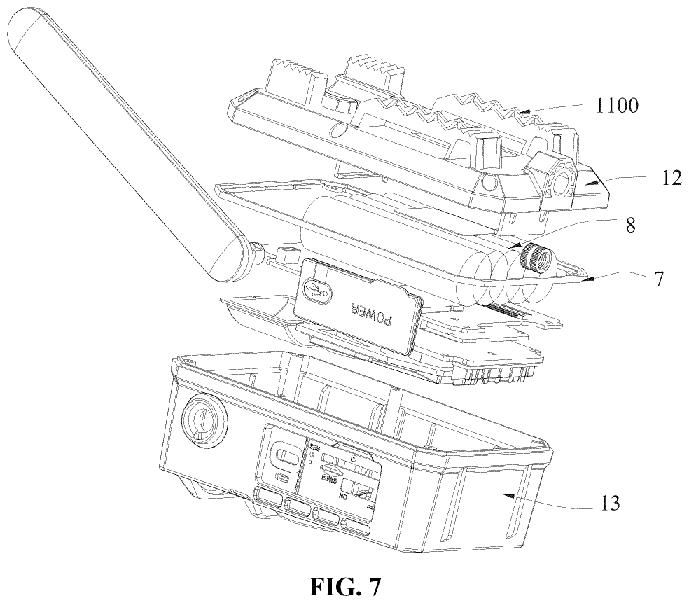

Referring to FIG. 1 to FIG. 7, a hunting camera is provided by the present disclosure. The hunting camera includes a camera main body 1 and a solar panel 2. The solar panel 2 can be detachably mounted on the camera main body 1. The solar panel can be detachably connected with the camera main body through a support, and also can be directly connected with the camera main body. The solar panel can be arranged according to the service condition of the user by manufacturers. The solar panel 2 is electrically connected with the camera main body 1. The solar panel can be used for supplying power for the camera main body, and the camera main body is mainly used for shooting or video recording. That is to say, the camera main body is connected to a solar panel, and the camera can be powered through the solar panel, so that the service time of the hunting camera is prolonged. The solar panel is detachably connected with the camera main body, so the solar panel can be placed at sunny places. The camera main body can be placed at an appropriate place to capture shooting, so that the camera is convenient for the user to use, the practicality of the hunting camera is increased, and the user experience is improved. Certainly, the solar panel can also be directly mounted on the camera main body for use, and the user can choose the mounting type according to the scene at that time.

In the embodiment, the solar panel 2 can be detachably mounted on the camera body 1. Preferably, the solar panel 2 is detachably connected with the camera main body through the support 3. The solar panel 2 is arranged at one end of the support 3, and the other end of the support 3 is detachably arranged on the camera main body 1. Because of the support 3, after the solar panel is disassembled from the camera main body, the solar panel is convenient for the user to mount somewhere. If there is no support 3, the solar panel is inconvenient for the user to mount independently.

In the embodiment, more than one preformed hole 31 is formed in the support 3, so that the support 3 is connected with a platform through the preformed hole 31 by using a fixed part 301. For example, the fixed part is a bolt, a screw, a rivet or other parts, but the connection between the support and the platform can also be rope binding. The support is directly bound on the platform through rope binding. Here, direct connection to the platform is in various types, and is not limited here. The platform here can be a tree, a wall or the ground. The platform refers to a place which can be fixed relative to the support and can be various objects, which is not limited here.

In the embodiment, a plug-in mounting groove 11 is formed in a side face of the camera main body 1. An elastic clamp 21 is arranged at an opposite end of one end, provided with the solar panel 2, of the support 3. The elastic clamp 21 includes a first elastic part 211 and a second elastic part 212. The first elastic part 211 and the second elastic part 212 are arranged in parallel. Outer side faces of the first elastic part 211 and the second elastic part 212 are provided with lugs 213. The support 3 is respectively clamped to tail ends of two side walls 111 of the plug-in mounting groove 11 through the two lugs 213 on the elastic clamp 21. That is to say, the bottom of the plug-in mounting groove is not provided with a proximal wall or two side walls 111 of the plug-in mounting groove 11 are not connected with the proximal wall. There are two notches capable of accommodating the first elastic part and the second elastic part, and the first elastic part and the second elastic part can move in the notches. In the embodiment, the lugs on the first elastic part and the second elastic part also can be clamped to the proximal wall without the limitation of being clamped to the tail ends of the two side walls, so that the solar panel 2 is mounted on the camera main body 1. The support is convenient for the user to disassemble with a single hand by the elastic clamp. The support can be disassembled just by pinching the first elastic part 211 and the second elastic part 212 to be extruded inwards. The first elastic part 211 and the second elastic part 212 can be recovered by loosening the first elastic part 211 and the second elastic part 212, and more components and parts are not needed. If bolts are used for mounting, the disassembly is relatively troublesome for the user. The lugs mainly play a clamping role, and the support is conveniently mounted on the camera main body by the user.

In the embodiment, the plug-in mounting groove 11 is internally provided with a guide rail 112 along a plug-in mounting direction of the support 3. A guide groove 32 is formed in the support 3. The guide groove 32 can slide along the guide rail 112. The support is more convenient for the user to mount by the guide rail 112 and the guide groove 32.

In the embodiment, tail ends of two side walls of the plug-in mounting groove 11 are provided with lengthened sections 113. The lengthened sections 113 are lengthened towards mutually approaching directions. The lugs 213 on the first elastic part 211 and the second elastic part 212 are respectively clamped to the lengthened sections 113. The user knows where clamping blocks need to be clamped at the first sight. If no lengthened sections are arranged, the new user does not how to mount the support without the guidance of specification. Moreover, if no lengthened sections are arranged, the clamping blocks are directly clamped to the tails of two side walls of the plug-in mounting groove.

In the embodiment, top surfaces of two side walls 111 of the plug-in mounting groove 11 are provided with bulges 1111 extended towards the inner direction of the plug-in mounting groove 11. A first gap 1112 is formed between the bulge 1111 and a side wall of the camera main body 1. Both sides of the support 3 are pluggable in the first gaps 1112. When the solar panel is mounted on the camera main body for use, the support is mounted more stably through the structure. The support and the camera main body are unlikely to fall off, so that the hunting camera is higher in using installability.

In the embodiment, the solar panel 2 is movably arranged on the support 3, so that the adjusting angle of the solar panel can be adjusted by the user. The solar panel is adjusted according to the direction of sun illumination, so that the solar panel can receive sunlight preferably.

In the embodiment, the hunting camera also includes a connecting piece 4. One end, connected with the solar panel 2, of the support 3 is provided with a first connecting plate 33. A first mounting hole 331 is formed in the first connecting plate 33. The bottom of the solar panel 2 is provided with a second connecting plate 22. A second mounting hole 221 is formed in the second connecting plate 22. The connecting piece 4 is pluggable in the first mounting hole 331 and the second mounting hole 221 so that the solar panel 2 is connected with the support 3. The solar panel 2 is rotatably connected to the connecting piece 4 through the second connecting plate 22, so the solar panel 2 is rotatably connected with the support 3, and the angle of the solar panel can be adjusted. In the embodiment, the first connecting plate 33 and the support 3 are integrally formed. The second connecting plate 22 is arranged on one mounting plate 220. The mounting plate can be fixedly arranged on the back face of the solar panel. The second connecting plate 22 and the mounting plate 220 are integrally formed, so the second connecting plate 22 and the first connecting plate 33 are unlikely to break and long in service life, and the mold stripping of the support and the mounting of the second connecting plate are also facilitated.

In the embodiment, the support 3 includes a transverse plate 34 and a vertical plate 35. One end of the vertical plate 35 is connected with the camera main body 1, and the other end of the vertical plate 35 is connected with one end of the transverse plate 34. The transverse plate 34 and the vertical plate 35 are vertically arranged. The first connecting plate 33 is arranged at the other end of the transverse plate 34. The structure facilitates the adjustment for the solar panel.

In the embodiment, the transverse plate 34 and the vertical plate 35 are integrally formed, and reinforcing ribs 36 are arranged at the joint of the transverse plate 34 and the vertical plate 35. The reinforcing ribs 36 are integrally formed with the transverse plate 34 and the vertical plate 35, so that the loading capacity of the support is relatively high.

In the embodiment, three first connecting plates 33 are arranged. Two second connecting plates 22 are arranged. A second gap 332 is formed between every two first connecting plates 33. When the first connecting plates 33 and the second connecting plates 22 are connected with the connecting piece 4, one of the second connecting plates 22 is located in one second gap 332, and the other of the second connecting plates 22 is located in the other second gap 332. Through the structural arrangement, the stability when the solar panel is rotated by the user is higher.

In the embodiment, the connecting piece 4 includes a bolt 41 and a nut 42. An axial part 411 of the bolt 41 includes a threaded section 4111 and a smooth section 4112. The threaded section 4111 is arranged at the tail of the axial part of the bolt 41. The smooth section 4112 is arranged between a bolt head part 412 of the bolt 41 and the threaded section 4111. The bolt 41 is pluggable in the first mounting hole 331 and the second mounting hole 221. When the bolt 41 is plugged in the first mounting hole 331 and the second mounting hole 221, the first connecting plate 33 and the second connecting plate 22 are connected to the smooth section 4112, and the nut 42 is detachably connected to the threaded section 4111. Through the structure, the solar panel is convenient to lock.

In the embodiment, the bolt head part 412 of the bolt 41 includes a handheld part 4121. A nut hole 3310 corresponding to the first mounting hole 331 is formed in the first connecting plate 33. The nut 42 can be arranged in the nut hole. When the nut 42 is arranged in the nut hole, the nut cannot rotate inside the nut hole, so the bolt 41 and the nut 42 can be disassembled without using tools by the user through the structure, and the solar panel can be disassembled from the support.

In the embodiment, the bolt head part 412 of the bolt 41 also includes a lengthened part 4122, and the lengthened part 4122 is arranged between the handheld part 4121 and the smooth section 4112, so that the bolt and the nut are further convenient for the user to disassemble.

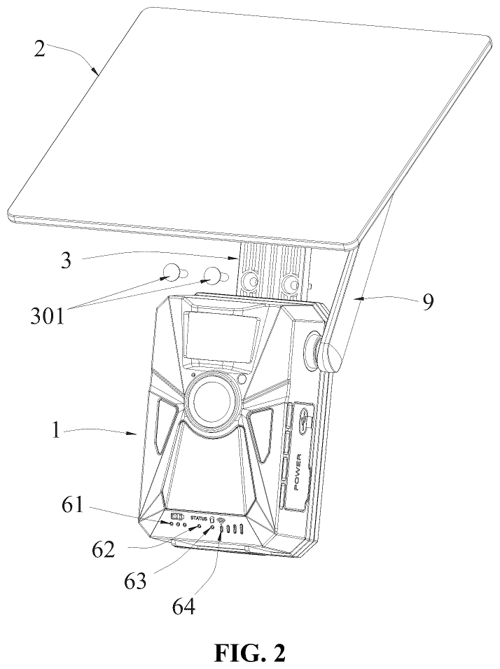

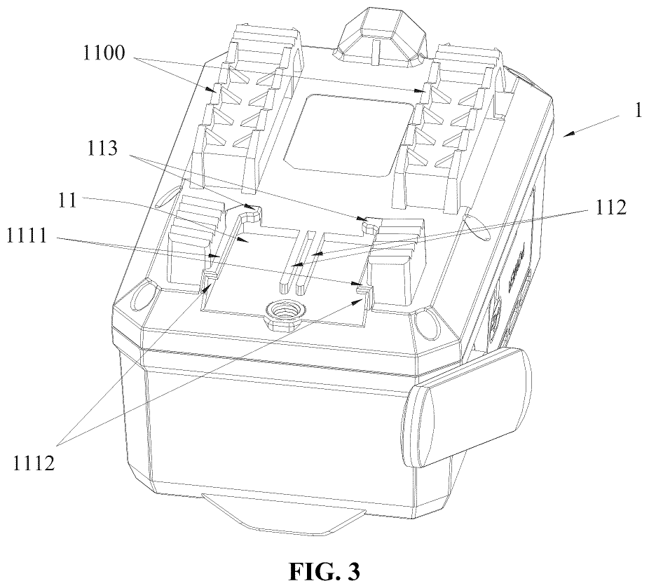

In the embodiment, the hunting camera also includes a display screen 5. The display screen 5 is arranged on the front face 101 of the camera body 1, so that the dynamic state of capturing is watched by the user in real time. Certainly, it can also be unnecessary to be provided with a display screen, and the cost is improved to a certain extent because of the arrangement of the display screen. Therefore, whether the hunting camera is provided with a display screen or not can be determined according to the requirements of various users. The cost of the hunting camera without a display screen is lower than that of the hunting camera with a display screen. The functional arrangement of the camera main body of the hunting camera without a display screen is as shown in FIG. 2. The functional arrangement of the camera main body of the hunting camera with a display screen is as shown in FIG. 1. Except some inconsistent functional buttons, the rest of the camera main body of the hunting camera without a display screen is the same as the rest of the camera main body of the hunting camera with a display screen. For example, a connecting structure between the support and the solar panel is as shown in FIG. 3 to FIG. 7.

In the embodiment, the hunting camera also includes indicator lights 6, and the indicator lights 6 are used for displaying signals. For example, in the embodiment, the indicator lights 6 can include a power indicator light 61, a camera starting state indicator light 62, a card-insertion state indicator light 63, a signal connection indicator light 64 and the like.

In the embodiment, the hunting camera also includes a waterproof ring 7 and a battery 8. The camera main body 1 also includes an upper shell 12 and a lower shell 13. The upper shell 12 and the lower shell 13 are mutually closed. A gap closed between the upper shell 12 and the lower shell 13 is sealed by the waterproof ring 7 to form a sealing cavity. The battery 8 is arranged in the sealing cavity. The upper shell and the lower shell are fixed and cannot be disassembled, so that the camera main body can be provided with a charging connector to prevent insufficiency in power after no power supply of solar energy. Through the arrangement of the waterproof ring 7, the interior of the camera is prevented from being immersed in water, and components and parts inside the camera are prevented from being damaged.

In the embodiment, the upper shell 12 and the lower shell 13 are fixedly connected. The upper shell 12 and the lower shell 13 are fixedly connected, so that poor waterproof performance caused by disassembly by the user is prevented. Moreover, the camera is damaged to a certain extent due to poor disassembly, so the upper shell 12 and the lower shell 13 are fixedly connected.

In the embodiment, the back face of the camera main body is also provided with pyramidal wave anti-skid pieces 1100. Through pyramidal wave, the frictional force can be increased. When the camera is mounted on the platform by the user, the camera is mounted more stably and is unlikely to slide off.

In the embodiment, the hunting camera also includes a signal antenna 9 electrically connected with the camera main body. The hunting camera is also provided with a control button, an on-off button and the like which are arranged on a side face or a front face of the camera main body. The buttons are waterproof, and unnecessary details are not given here specifically through normal arrangement.

In conclusion, according to the hunting camera, the solar panel can be disassembled from the camera main body to be mounted at sunny places. The camera main body can be mounted at some places with good visual field, so the practicality of the camera is increased, and the camera is convenient to use. The support is convenient for the user to disassemble through the arrangement of the elastic clamp. The adjusting angle of the solar panel can be adjusted, so the user experience is increased.

It should be understood that the application of the present disclosure is not limited to the embodiments mentioned above. Those of ordinary skill in the art can obtain improvements or modifications based on the above descriptions. All such improvements and modifications should fall within the scope of protection of the claims of the present disclosure.

What is claimed is:

1. A hunting camera, comprising a camera main body and a solar panel, wherein the solar panel is detachably mounted on the camera main body and electrically connected with the camera main body.

2. The hunting camera according to claim 1, wherein the hunting camera also comprises a support, the solar panel is arranged at one end of the support, and the other end of the support is detachably arranged on the camera main body.

3. The hunting camera according to claim 2, wherein more than one preformed hole is formed in the support, so that the support is connected with a platform through the preformed hole by using a fixed part.

4. The hunting camera according to claim 2, wherein a plug-in mounting groove is formed in a side face of the camera main body, an elastic clamp is arranged at an opposite end of one end, provided with the solar panel, of the support, the elastic clamp comprises a first elastic part and a second elastic part, the first elastic part and the second elastic part are arranged in parallel, outer side faces of the first elastic part and the second elastic part are provided with lugs, the support is respectively clamped to tail ends of two side walls of the plug-in mounting groove through the two lugs on the elastic clamp so that the solar panel is mounted on the camera main body.

5. The hunting camera according to claim 4, wherein the plug-in mounting groove is internally provided with a guide rail along a plug-in mounting direction of the support, a guide groove is formed in the support, and the guide groove can slide along the guide rail.

6. The hunting camera according to claim 4, wherein tail ends of two side walls of the plug-in mounting groove are provided with lengthened sections, the lengthened sections are lengthened towards mutually approaching directions, and the lugs on the first elastic part and the second elastic part are respectively clamped to the lengthened sections.

7. The hunting camera according to claim 4, wherein top surfaces of two side walls of the plug-in mounting groove are provided with bulges extended towards the inner direction of the plug-in mounting groove, a first gap is formed between the bulge and a side wall of the camera main body, and both sides of the support are pluggable in the first gaps.

8. The hunting camera according to claim 2, wherein the solar panel is movably arranged on the support.

9. The hunting camera according to claim 8, wherein the hunting camera also comprises a connecting piece, one end, connected with the solar panel, of the support is provided with a first connecting plate, a first mounting hole is formed in the first connecting plate, the bottom of the solar panel is provided with a second connecting plate, a second mounting hole is formed in the second connecting plate, the connecting piece is pluggable in the first mounting hole and the second mounting hole so that the solar panel is connected with the support, and the solar panel is rotatably connected to the connecting piece through the second connecting plate.

10. The hunting camera according to claim 9, wherein the support comprises a transverse plate and a vertical plate, one end of the vertical plate is connected with the camera main body, the other end of the vertical plate is connected with one end of the transverse plate, the transverse plate and the vertical plate are vertically arranged, and the first connecting plate is arranged at the other end of the transverse plate.

11. The hunting camera according to claim 9, wherein the transverse plate and the vertical plate are integrally formed, and reinforcing ribs are arranged at the joint of the transverse plate and the vertical plate.

12. The hunting camera according to claim 9, wherein three first connecting plates are arranged, two second connecting plates are arranged, a second gap is formed between every two first connecting plates, and when the first connecting plates and the second connecting plates are connected with the connecting piece, one of the second connecting plates is located in one second gap, and the other of the second connecting plates is located in the other second gap.

13. The hunting camera according to claim 9, wherein the connecting piece comprises a bolt and a nut, an axial part of the bolt comprises a threaded section and a smooth section, the threaded section is arranged at the tail of the axial part of the bolt, the smooth section is arranged between a bolt head part of the bolt and the threaded section, the bolt is pluggable in the first mounting hole and the second mounting hole, and when the bolt is plugged in the first mounting hole and the second mounting hole, the first connecting plate and the second connecting plate are connected to the smooth section, and the nut is detachably connected to the threaded section.

14. The hunting camera according to claim 13, wherein the bolt head part of the bolt comprises a handheld part, a nut hole connected with the first mounting hole is formed in the first connecting plate, and when the axial part of the bolt is plugged in the first mounting hole, the threaded section is located in the nut hole, and the nut can be mounted in the nut hole.

15. The hunting camera according to claim 14, wherein the bolt head part of the bolt also comprises a lengthened part, and the lengthened part is arranged between the handheld part and the smooth section.

16. The hunting camera according to claim 1, wherein the hunting camera also comprises a display screen, and the display screen is arranged on a front face of the camera main body.

17. The hunting camera according to claim 1, wherein the hunting camera also comprises indicator lights, and the indicator lights are used for displaying signals.

18. The hunting camera according to claim 17, wherein the indicator lights comprise a power indicator light, a camera starting state indicator light, a card-insertion state indicator light and a signal connection indicator light.

19. The hunting camera according to claim 1, wherein the hunting camera also comprises a waterproof ring and a battery, the camera main body also comprises an upper shell and a lower shell, the upper shell and the lower shell are mutually closed, a gap closed between the upper shell and the lower shell is sealed by the waterproof ring to form a sealing cavity, and the battery is arranged in the sealing cavity.

20. The hunting camera according to claim 19, wherein the upper shell and the lower shell are fixedly connected.
